(19) United States
(12) Patent Application Publication
(10) Pub. No.: US 2002/0046074 A1
(43) Pub. Date: Apr. 18, 2002

(54) Career management system, method and computer program product

(76) Inventor: Timothy Barton, Atlanta, GA (US)

Correspondence Address: VENABLE, BAETJER, HOWARD AND CIVILETTI, LLP, P.O. BOX 34385, WASHINGTON, DC, 20043-9998, US

(21) Appl. No.: 09/893,494

(22) Filed: Jun. 29, 2001

Related U.S. Application Data
(60) Provisional application No. 60/215,117, filed on Jun. 29, 2000.

(51) Int. Cl. G06F 17/60

(52) U.S. Cl. 705/8

(57) ABSTRACT

A method for managing a client's search for a candidate can include requisitioning a job; describing a job; defining a candidate; searching an internal talent pool of candidates; searching an external talent pool of candidates; screening candidates; managing selection of the candidates; managing offer and hire of the candidates; and managing an on-board process. Alternatively, the method can include, at least one of: requisitioning a job; describing a job; defining a candidate; searching an internal talent pool of candidates; searching an external talent pool of candidates; screening candidates; managing selection of the candidates; managing offer and hire of the candidates; and managing an on-board process. A method for managing a job search of a candidate can include: performing a self assessment; building a resume; preparing a cover sheet; researching; networking; searching for a job; scoring a job; interviewing; sending a thank you letter; evaluating an offer; resigning from a prior position; and managing an on-board process. Alternatively, the method can include at least one of: performing a self assessment; building a resume; preparing a cover sheet; researching; networking; searching for a job; scoring a job; interviewing; sending a thank you letter; evaluating an offer; resigning from a prior position; and managing an on-board process.

### CROSS-REFERENCE TO RELATED APPLICATION

This is a non-provisional patent application of U.S. Provisional Patent Application Serial No. 60/215,117 to “Career Management System, Method and Computer Program Product” to BARTON, filed Jun. 29, 2000, the contents of which is incorporated herein by reference in its entirety.

### BACKGROUND OF THE INVENTION

1. Field of the Invention

The present invention relates generally to employment recruiting and career management services and more particularly to online computer-driven interactive employment recruiting and career management services.

2. Related Art

U.S. employers have created an annual $251 billion recruiting market economy. Recruitment of sales and marketing functions, are projected to be $52.8 billion of that annual spending. Turnover in Sales and Marketing is almost double the turnover of any other function. Employers have found that recruiting and retaining qualified talent has become a top critical success factor for sustaining competitive advantage. Unemployment among knowledge workers is about 1% and employees entering into the work place today can average 8-10 employers over their career versus the 2-3 employers of just 20 years ago.

Executive recruiters, such as, e.g., Barton Executive Search of Atlanta, Ga. U.S.A. have provided executive search services within various industry segments, including, e.g., consumer products, e-commerce, financial services, and entertainment industries. A client refers to, e.g., a business employer for which an executive recruitment engagement is directed. A candidate refers to, e.g., an potential employee recruit to which the executive recruitment engagement is directed. It is important to note that although much of this application is directed to executive recruitment and in particular to the recruitment of sales and marketing executives, it will be apparent to those skilled in the relevant art that the processes, techniques, systems, methods and computer program products described are equally applicable to other types of clients and candidates. As internet usage increases and online recruiting as a medium evolves from early adopter into mass market relevance, various limitations have been identified with conventional online recruiting. Limitations with online recruiting, experienced by both candidates and clients, include inadequate search capabilities, search criteria too broad, unqualified candidates, irrelevant jobs for candidates, lack of accountability, only short term relationships, impersonal, and workflow is unduly cumbersome.

Clients are struggling to find a recruiting solution that delivers, e.g., middle to lower level sales and marketing candidates in a cost effective, fast, and quality manner and manages the workflow of the recruiting process. Clients are frustrated with the number of irrelevant and unqualified candidates that conventional online recruiting companies deliver and are concerned that no conventional online recruiting companies have been able to provide a solution that is not fragmented.

Thus, what is needed then is an end-to-end solution for managing the workflow of recruiting candidates online, from candidate identification, to assessment, and through to candidate placement, overcoming shortcomings of conventional solutions. Additionally clients need a method that integrates the client employer's accepted tools and systems to screen and qualify candidates, that overcome the limitations of conventional systems and methods.

### SUMMARY OF THE INVENTION

A method, system, and computer program product operative to provide an end-to-end employee recruitment solution is disclosed. In an exemplary embodiment, the method can include, e.g., managing the workflow of a client's candidate job search in an online recruiting environment, from candidate identification, to assessment, and to candidate placement. In an exemplary embodiment, the method can use, e.g., client employer's accepted tools and systems to screen and qualify the candidates.

The present invention overcomes the shortcomings of conventional solutions.

In an exemplary embodiment of the present invention, the method of the client's candidate job search can include a multiple step recruitment process. In a preferred embodiment, a 9-step process can be used. The process, in an exemplary embodiment can include multiple proprietary tools and industry leading content to manage work-flow of the search process.

In an exemplary embodiment, a system, method and computer program product for managing a client's job search can include: requisitioning a job; describing a job; defining a candidate; searching an internal talent pool of candidates; searching an external talent pool of candidates; screening candidates; managing selection of the candidates; managing offer and hire of the candidates; and managing an on-board process.

In another exemplary embodiment, a system, method and computer program product for managing a client's job search can include at least one of: requisitioning a job; describing a job; defining a candidate; searching an internal talent pool of candidates; searching an external talent pool of candidates; screening candidates; managing selection of the candidates; managing offer and hire of the candidates; and managing an on-board process.

In an exemplary embodiment of the present invention, the method can include a live recruiting team can assist the client with any or all of the multiple step recruitment process, preferably assisting with the 9-step recruiting process. The live recruiting team can use tools available from, e.g., an online career management company CareerElite.com and/or other methodologies and/or client employer specific tools and methodologies as requested by the client.

In an exemplary embodiment, the method can include a pay-for-performance fee schedule can be included in the present invention.

In an exemplary embodiment, the method can include a proprietary database technology can allow clients to search by industry, function, level, position, and geography, which can deliver only relevant candidates to the client.

In an exemplary embodiment, the method can include a carefully selected and pre-qualified group of strategic partners for client companies to use in areas such as, e.g., diversity training, compensation, and benefits.

In an exemplary embodiment, the method can include an application service provider (ASP) operative to enable clients to assimilate into the client's recruitment site to facilitate their own direct recruitment initiatives.

In an exemplary embodiment, the method can include outplacement services for displaced candidates and/or for spouses of relocated candidates, internal or externally relocated.

In an exemplary embodiment, a business method for generating revenues from recruiting candidates for clients can include transmission of compensation between business entities in a client business to recruiting business (B2B) model. Exemplary embodiments of revenue transfers can include, e.g., placement fees, retainers, database search fees, recruiting consulting services fees, outsourced logistics coordination fees, outplacement fees, and/or an ASP model.

In an exemplary embodiment, the method can generate revenues from candidates in a business to candidate consumer(B2C) model in the form of, e.g., career consulting.

In an exemplary embodiment, the method can generate revenues from clients in a business to employer client (B2E) model in the form of, e.g., outplacement and/or spousal support.

In an exemplary embodiment, the method can market separately to candidates and/or clients to build brand awareness and product trial. In an exemplary embodiment, the method can include teams located in a central location and/or in home-based offices throughout a geographic area.

In another exemplary embodiment, a method can include, e.g., a candidate's career management process and a candidate's job search in an online recruiting environment throughout an entire career of the candidate.

In an exemplary embodiment of the present invention, the method of the candidate's career management process and the candidate's job search can include a multiple step process. In a preferred embodiment, a 12-step process can be used. The process, in an exemplary embodiment can include multiple proprietary tools and industry leading content to manage work-flow of the search process.

In an exemplary embodiment, a system, method and computer program product for managing a candidate's job search can include: performing a self assessment; building a resume; preparing a cover sheet; researching; networking; searching for a job; scoring a job; interviewing; sending a thank you letter; evaluating an offer; resigning from a prior position; and managing an on-board process.

In another exemplary embodiment, a system, method and computer program product for managing a candidate's job search can include at least one of: performing a self assessment; building a resume; preparing a cover sheet; researching; networking; searching for a job; scoring a job; interviewing; sending a thank you letter; evaluating an offer; resigning from a prior position; and managing an on-board process.

The present invention advantageously features, in an exemplary embodiment, a novel end-to-end solution covering the entire employment recruiting process, a revenue model including pay for performance, live consultants to manage the career recruiting process, an application service provider (ASP) offering for client human resources departments, superior search capabilities for candidates and clients, industry leading technological tools and solutions, or full accountability including a one year guarantee to clients.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digits in the corresponding reference number.

### BRIEF DESCRIPTION OF THE DRAWINGS

The foregoing and other features and advantages of the invention will be apparent from the following, more particular description of a preferred embodiment of the invention, as illustrated in the accompanying drawings.

FIG. 1 depicts an exemplary embodiment of a block diagram illustrating the system of the present invention;

FIG. 2 depicts an exemplary embodiment of a flow diagram illustrating an exemplary client acquisition process according to the present invention;

FIG. 3 depicts an exemplary embodiment of a flow diagram illustrating an exemplary candidate search process according to the present invention;

FIG. 4 depicts an exemplary computer system;

FIG. 5 depicts and exemplary implementation embodiment illustrating public servers and databases, and client-specific servers and databases;

FIG. 6 illustratively depicts a self assessment prioritization tool in accordance with the present invention;

FIG. 7 depicts an exemplary embodiment of an offer evaluation comparison tool according to the present invention having factors ordered according to prioritization determined in the assessment prioritization tool depicted in FIG. 6;

FIG. 8 depicts an exemplary embodiment of a candidate definition tool for use by a client in accordance with the present invention;

FIG. 9 depicts an exemplary embodiment of an interview guide generated as a result of input captured in the candidate definition tool;

FIG. 10 depicts an exemplary embodiment of a job scorecard by which a candidate can manage various job interviews according to the present invention; and

FIG. 11 depicts an exemplary embodiment of a cross-industry cross-level job function and job title job search window illustrating performing a cross-level search query.

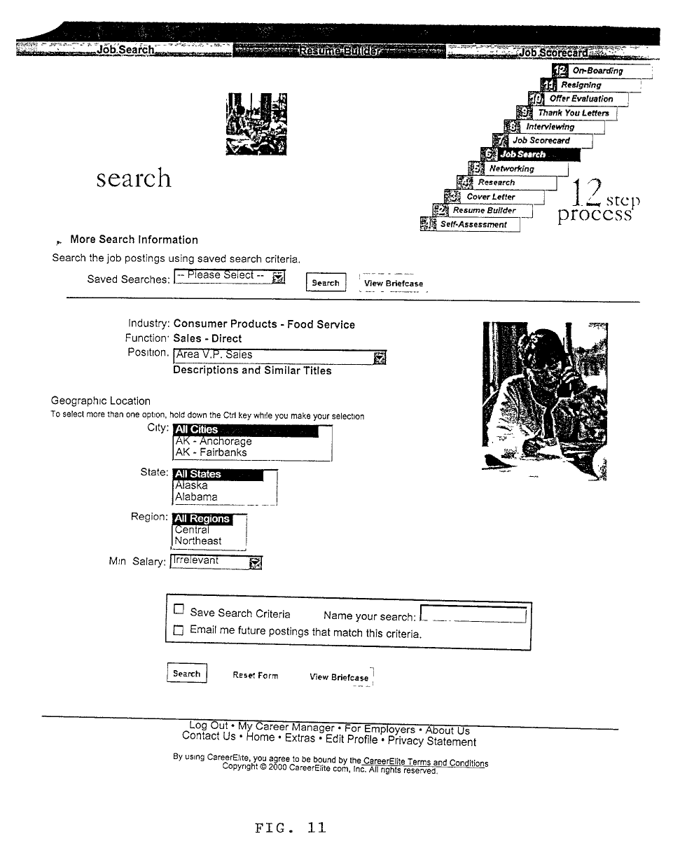

### DETAILED DESCRIPTION OF EXEMPLARY EMBODIMENTS OF THE INVENTION

A preferred embodiment of the invention is discussed in detail below. While specific implementations are discussed, it should be understood that this is done for illustration purposes only. A person skilled in the relevant art will recognize that other components and configurations may be used without parting from the spirit and scope of the invention.

An Exemplary Implementation of an Embodiment of the Invention

The present invention is directed to an improved demographic and behavioral analysis system architecture for use in, e.g., identifying tracking and understanding user behavior on the Internet and in traditional stores.

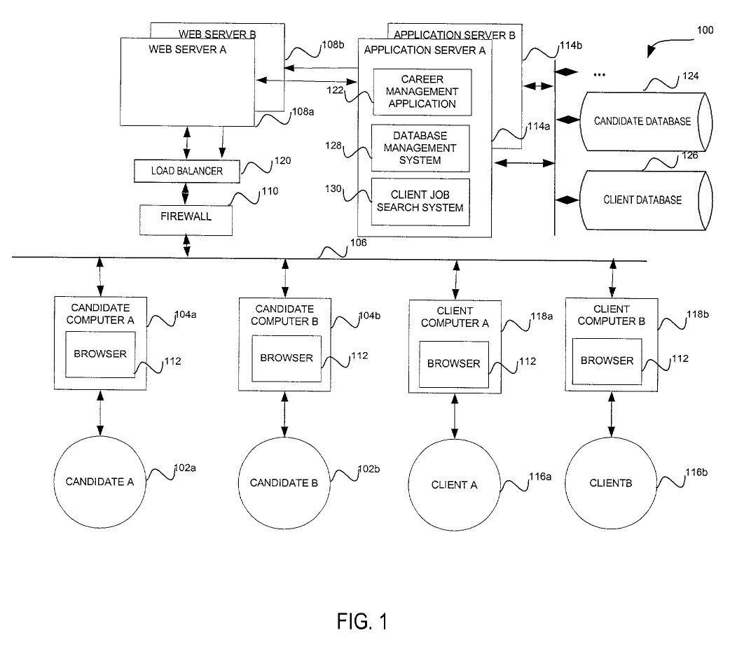

FIG. 1 depicts a high level block diagram of an exemplary embodiment of an implementation of the present invention. Specifically, FIG. 1 illustratively depicts a block diagram 100 of an exemplary embodiment of an online career management and recruiting environment according to the present invention. Block diagram 100 can include, e.g., one or more candidates 102a, 102b interacting with one or more candidate computers A 104a and B 104b. The candidate computers 104a, 104b can be coupled to a network 106. Block diagram 100 can further include, e.g., one or more clients 116a, 116b interacting with one or more client computers A 118a and B 118b. The client computers 118a, 118b can be coupled to the network 106. Each of computers 104a, 104b; and 118a, 118b can include a browser such as, e.g., an internet browser such as, e.g., NETSCAPE NAVIGATOR available from America Online of Vienna, Va., U.S.A., and MICROSOFT INTERNET EXPLORER available from Microsoft Corporation of Redmond, Wash., U.S.A.

The candidate computers 104a, 104b and client computers 118a, 118b can interact with the system of the present invention according to conventional techniques. In an exemplary embodiment of the present invention, candidates 102a and 102b and clients 116a and 116b can use browsers 112 to create hypertext transfer protocol (HTTP) requests of a universal resource locator (URL) of a file on at least one of a web server A 108a and a web server B 108b. Incoming requests from the candidate computers 104a, 104b and client computers 118a, 118b can go through a firewall 110 and can be routed via, e.g., a load balancer 120 to one of web servers 108a, 108b. The web servers can provide, e.g., session management with the candidate computers 104a, 104b and client computers 118a, 118b. The requests can be sent from the web servers 108a, 108b to one of an application server A 114a or an application server B 114b. Application servers 114a, 114b can run any of various applications including, e.g., a candidate career management application 122, a client job search management application 130, and a database management system 128. The application programs 122, 130, 128 can access any of various databases including, e.g., candidate database 124 and client database 126.

The conventional online search market place, as reported by a recent Yankelovich Partners' study, is little more than a digital bulletin board for classified ads, generating too many irrelevant candidate applicants, Too many low quality candidate applicants, and lacking personal contact with the candidates. The present invention overcomes shortcomings of conventional solutions by providing online proprietary technology, tools, and resources combined with a personal consultative approach, which produces “Best of Class” candidates in a timely, cost effective manner.

Despite the advent of numerous on-line recruiting sites, the search process remains a confusing and intimidating experience for candidates. The outcome of a search is typically too many unrelated jobs and a lack of personal coaching throughout the job search process. The outcome of a typical client search holds similar frustrations and disappointment, producing irrelevant and unqualified candidates.

For Clients, the present invention includes, in an exemplary embodiment,

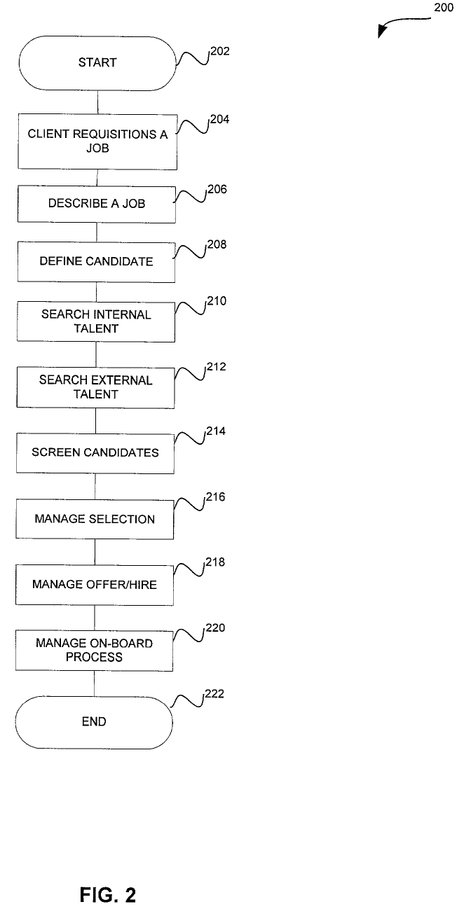

A 9 step recruitment process loaded with proprietary tools and industry leading content to manage the work-flow of the search process; The 9 step process carries a client up a series of steps using a stair metaphor graphical user interface as illustrated below: For further details, the reader is directed to the description of FIG. 2 and the printed selections from the beta website, below; Thus the client can be taken end-to-end through the client's candidate job search process, and can perform a subset of these steps, as needed;

[chemical structure]

A live recruiting team to assist the client with any or all steps in the 9-step recruiting process, using proprietary tools and methodologies or employer specific tools and methodologies;

A pay-for-performance fee schedule;

A proprietary database technology that allows clients to search by industry, function, level, position, and geography, which will deliver only relevant candidates; This technology can allow clients to quickly and easily review search results, select, view, and summarize a short list of relevant candidates, thus streamlining a very time consuming process;

A carefully selected and pre-qualified group of strategic partners for clients to use in areas such as diversity training, compensation, and benefits;

An ASP that employers can assimilate onto their company recruitment site to facilitate their own direct recruitment initiatives; and

Outplacement services for displaced employees and for spouses of relocated internal/external candidates.

For Candidates, in an exemplary embodiment the present invention includes:

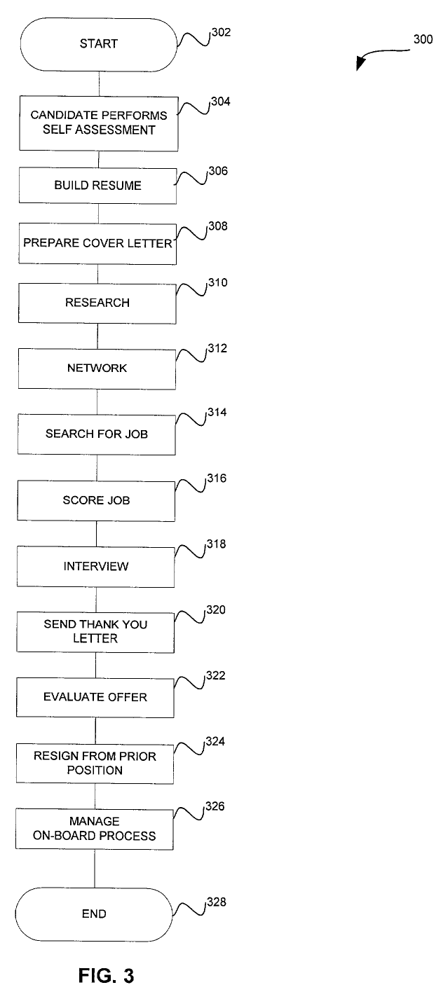

A 12-Step recruitment process loaded with proprietary tools and industry leading content to manage the work-flow of the job search process; The 12 step process carries a candidate up a series of steps using a stair metaphor graphical user interface as illustrated below; For further details, the reader is directed to the description of FIG. 3 and the printed selections from the beta website, below; Thus the candidate is taken end-to-end through the job search process, and can perform a subset of these steps, as needed;

[chemical structure]

A live Career Coaching team to assist candidates through any or all steps in the 12-step process, using tools and methodologies available at the CareerElite.com career services provider, exemplary tools are included below from the beta website;

A proprietary database technology that can allow candidates to search by industry, function, level, position, geography, and compensation, which will quickly deliver only relevant positions; This technology can allow candidates to quickly and easily review search results and select, view, and summarize a list of relevant opportunities; and

Strategic partners that can offer subject matter expertise in areas such as retirement planning, computer training, and relocation assistance.

For Associations, B2B & B2C Portals, the present invention can provide resources including:

An ASP model that delivers content, tools and technology to better serve communities (businesses and consumers) including:

Private Label Application,

Co-Branded Application, and

Link to CareerElite site.

FIG. 2 includes a flow diagram 200 illustrating an exemplary embodiment of the present invention. Flow diagram 200 can begin with step 202 and can continue immediately with step 204.

In step 204, a client can requisition a job placement engagement. From step 204, flow diagram 200 can continue with step 206.

In step 206, the job can be described. From step 206, flow diagram 200 can continue with step 208.

In step 208, a candidate can be defined to fill the job. From step 208, flow diagram 200 can continue with step 210.

In step 210, a search can be performed of internal talent. From step 210, flow diagram 200 can continue with step 212.

In step 212, a search can be performed of external talent. From step 212, flow diagram 200 can continue with step 214.

In step 214, candidates resulting from searches can be screened. From step 214, flow diagram 200 can continue with step 216.

In step 216, selections of candidates can be managed. From step 216, flow diagram 200 can continue with step 218.

In step 218, offers and hiring can be managed. From step 218, flow diagram 200 can continue with step 220.

In step 220, on-board process can be managed. From step 220, flow diagram 200 can immediately end with step 222.

FIG. 3 includes a flow diagram 300 illustrating an exemplary embodiment of the present invention. Flow diagram 300 can begin with step 302 and can continue immediately with step 304.

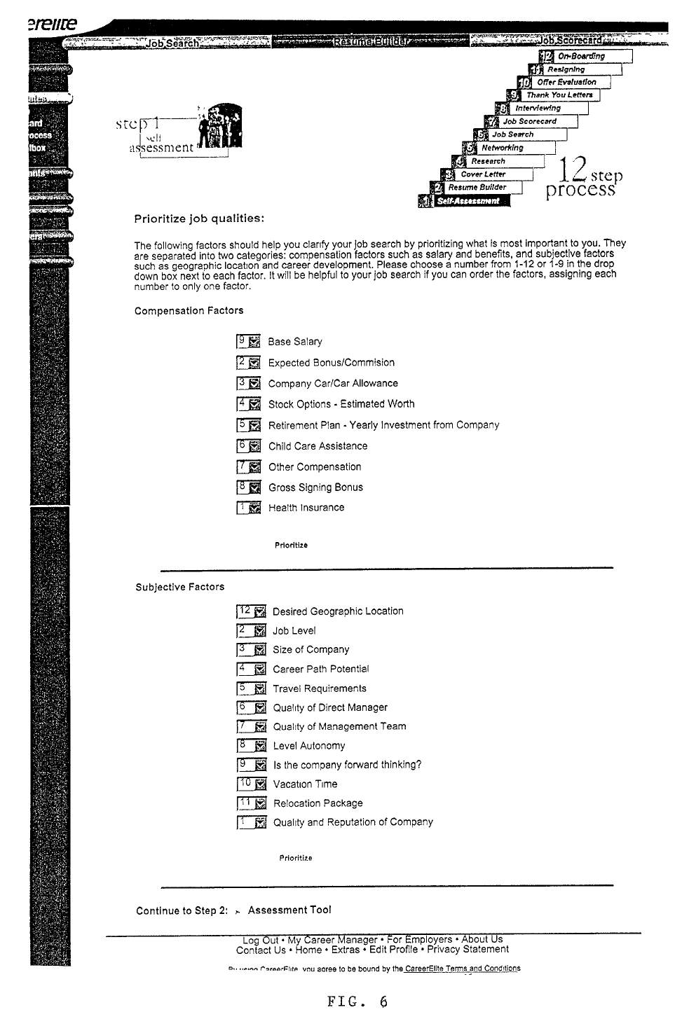

In step 304, a candidate can perform a self assessment as illustrated, for example in FIG. 6 below. From step 304, flow diagram 300 can continue with step 306.

In step 306, a candidate can build a resume. From step 306, flow diagram 300 can continue with step 308.

In step 308, a candidate can prepare a cover letter. From step 308, flow diagram 300 can continue with step 310.

In step 310, a candidate can research clients that the client may be interested in interviewing with. From step 310, flow diagram 300 can continue with step 312.

In step 312, a candidate can network to, e.g., identify potentially useful contacts at, e.g., clients. From step 312, flow diagram 300 can continue with step 314.

In step 314, candidates can search for available jobs. From step 314, flow diagram 300 can continue with step 316.

In step 316, jobs can be scored. From step 316, flow diagram 300 can continue with step 318.

In step 318, candidates can interview for a job. From step 318, flow diagram 300 can continue with step 320.

In step 320, candidates can send thank you letters. From step 320, flow diagram 300 can continue with step 322.

In step 322, candidates can evaluate offers. From step 322, flow diagram 300 can continue with step 324.

In step 324, candidates can resign from prior position. From step 324, flow diagram 300 can continue with step 326.

In step 326, candidates can manage an on-board process. From step 326, flow diagram 300 can immediately end with step 328.

Revenue Model

The present invention can generate revenue from the following sources:

“B to B” Revenue

Placement Fees

In an exemplary embodiment, placement fees for filling corporate positions can range from $2,000 to $10,000 per successful placement of a candidate according to the present invention. This is a substantial savings over fees traditional search firms charge and more cost effective than conventional on-line sites. In an exemplary embodiment, fees can range from 8% to 10% of the base salary of the candidate.

Retainers

In an exemplary embodiment, retainers can provide clients who have large numbers of open positions and a need for a client recruitment management service provider to manage a hiring process to receive services at a discount. The client, in an exemplary embodiment, can agree in advance to use services according to the present invention over a specified period of time and can pay the service provider a monthly retainer for those services. In an exemplary embodiment, at the end of the project the client can reimburse the service provider for any fees over and above the amount of the retainer.

Career Service Provider Database Search Fees

In an exemplary embodiment, employers can search the service provider's database of candidates for a fee or as a part of the client's retainer agreement. In an exemplary embodiment, fees can vary based on the number of database searches.

Career Service Provider Consultants

In an exemplary embodiment, clients can hire career service provider consultants such as, e.g., CareerElite Consultants from careerelite.com of Atlanta, Ga., U.S.A., for, e.g., recruiting services, including resume screening, phone and video conferencing interviews, candidate evaluation, and candidate selection.

Career Service Provider Recruiting Coordinators

In an exemplary embodiment, clients can hire career service provider Recruiting Coordinators for, e.g., the administration and coordination of candidate applications; interview scheduling, and general communications

Partnering Revenue

In an exemplary embodiment, career service provider can earn a fee and/or a percentage of the transaction when referring clients to our external partners. In an exemplary embodiment, strategic partners can provide subject matter expertise in areas that career service provider does not currently provide internally. In an exemplary embodiment, this subject matter expertise can be needed by clients to manage their day-to-day business. In an exemplary embodiment, some of these services can include, e.g., employment law, drug testing, background checks, and labor relations.

“B2E” Revenue

In an exemplary embodiment, career service provider outplacement service can be a comprehensive offering to terminated employees of client companies and to spouses of internal/external candidates of clients who can be relocated and can be required to find new employment.

“B2C” Revenue

Career Service Provider Consultants

In an exemplary embodiment, candidates can hire Career Service Provider Consultants at every point in the 12-step process illustrated in FIG. 3 above, for consulting services via phone or video conferencing. Examples can include, e.g., demo interviews, search strategy development, career management issues, reviewing the offer, and resigning from their current position.

Partnering Revenue

In an exemplary embodiment, Career Service Provider can earn a fee and/or a percentage of the transaction when referring candidates to our external partners. In an exemplary embodiment, strategic partners can provide subject matter expertise in areas that Career Service Provider does not currently provide internally. In an exemplary embodiment, this subject matter expertise can be needed by candidates to complete a successful job search process. In an exemplary embodiment, some of these services can include, e.g., retirement planning, computer training, buying and selling homes, and skill training.

Facilities of an Exemplary Career Services Provider

In an exemplary embodiment, a career services provider can include a corporate consulting center. The corporate consulting center can include, in an exemplary embodiment, open-air, call center-type offices with state-of the art telecommunications and computer equipment. The corporate consulting center can include a location for conducting a substantial portion of the career services provider consulting services for clients and candidates. A single initial facility can exist at a headquarters location, in an exemplary embodiment, and additional centers can be added as demand for consultants increases. In an exemplary embodiment, the career services provider can add consulting centers each time headcount approaches an incremental threshold of, e.g., 60 consultants. The first facility can also house a career college. In an exemplary embodiment, the career college can include a campus with classrooms and meeting rooms equipped with computer stations and multimedia training tools. The career college can be used for such uses including, e.g., orientation, certification training, continuing education, and group gatherings. The career services provider, in an exemplary embodiment can closely integrate consultants with overall staff to create and maintain interdependencies critical to success. The career services provider facilities can offer a highest level of handicap access to ensure attraction and accommodation of the broadest range of qualified professionals.

Customer Service—Career Services Provider HelpDesk

In an exemplary embodiment, the career services provider can outsource portions of customer service and/or HelpDesk support. Portions of both can be maintained inhouse for special control, in an exemplary embodiment. Customer service can be critical to success of a career services provider. As not a core competency of a career services provider, partnerships can be used to extend the organization. Partners can be completely trained on career services provider technology and operating procedures.

In an exemplary embodiment, the career services provider can operate a free, live HelpDesk function where site visitors can contact us the career services provider in “real time” via a 1-800 call feature or email. The HelpDesk can aid users in, e.g., using the web site (i.e. navigation, using the tools) and answering basic questions regarding the site. If questions are those that need professional consultation from career services provider Consultants, the HelpDesk personnel can aid the user in scheduling a callback. An online scheduler can also be available. In an exemplary embodiment, when used online, inputs can be monitored and integrated into a “master” schedule by the Customer Service team. Technical questions or billing questions that are not answerable by the HelpDesk personnel can be forwarded to career services provider personnel for, e.g., immediate handling, or on a callback basis, depending on priority.

Consultants

In another exemplary embodiment of the present invention, the career services provider can provide high quality, on-time HR consulting services to both clients (employers) and candidates (individuals). These consultants can perform services on an hourly, billable basis. The career services provider can have, in an exemplary embodiment, multiple types, e.g., 3 (three) types, of consultants serving candidates and clients including, e.g., contract recruiters, recruiting coordinators and career coaches.

Contract Recruiters can, in an exemplary embodiment, provide assistance to clients who determine that they would like assistance in managing their recruiting process. These consultants can, e.g., screen resumes; interview candidates; and perform background checks, e.g., to narrow the candidate pool down to the best prospects.

Recruiting Coordinators can, in an exemplary embodiment act similarly to the Contract Recruiters in that the recruiting coordinators can perform outsourced services for clients. Unlike contract recruiters, however, recruiting coordinators' work is highly administrative. The recruiting coordinator, in an exemplary embodiment, can assist by, e.g., obtaining compensation data from candidates; ordering drug tests; scheduling interviews on the client's premises; handling travel arrangements; and distributing client-company literature.

Career Coaches, in an exemplary embodiment, can deliver “live” counseling sessions to candidates that have begun using the 12 Step Process of the present invention. When candidates use the candidate career management system website and desire professional, “person to person” advice, contact can be made with career coaches. The career coaches, in an exemplary embodiment, can deliver “live” career coaching when clients incur outplacement needs and ask to help their former employees with career planning. Lastly, the coaches can serve clients and the clients' newly hired candidate employees by offering other services such as, e.g., spousal assistance.

Certification

The career services provider can select personnel for consultancy who possess a baseline of experience and competency in candidate management and recruiting or career counseling. The baseline of experience can enable a consultant to perform services in most, but not all, of the 9 Step Process (for Client Employers) and in most, but not all, of the 12 Step Process (for Candidates). Certification, in an exemplary embodiment, can mean that a consultant has been observed by career services provider management and has been deemed highly capable to accurately deliver end-to-end consulting services. In an exemplary embodiment, certification can be achieved via individual observation by a manager or certified consultant. In an exemplary embodiment, certification can enable a consultant to perform a full array of services, but can also carry several personal rewards for the career services provider associate, including, e.g., a 10% increase in base salary upon certification; matriculation to a new title of, e.g., Sr. Career Coach or Sr. Contract Recruiter, respectively; eligibility to observe and help certify other Consultants; ability to work on any/all engagements providing the most diverse work content; after a 90 day developmental observation period, the associate can be eligible to work from home; and eligibility to become a Group Manager (increased base salary and management role).

Personnel

In an exemplary embodiment of the career services provider, the target/core associate can bring a minimum of three years of human resources experience with a major employer. To supplement the core, the career services provider can target other pools of talent including, e.g.,: retired or late-career business people who have deep experiences coaching and mentoring co-workers; retired from full time, HR professionals seeking part-time, at-home work; teachers during the summer months interested in a 10 week contract; and persons with disabilities.

The career services provider can offer full and part-time roles. Because of the hands-on player/coach nature of the work, all managers can physically work in the consulting centers. Prior to certification and for a 90-day developmental observation period after certification, all personnel can be required to physically work in one of the consulting centers. After successfully completing that period and agreeing to a production maintenance contract, consultants can be offered the opportunity to work from home. The bulk of consulting sessions can occur between 4 p.m. and 1 a.m. Eastern Time. The career services provider can determine to maintain an adequate balance of in-office and remote workers.

Training Program

As consultants are recruited, the consultant is assessed for experience and competency in, e.g., candidate management, career counseling and recruiting. A first phase of training ,in an exemplary embodiment, occurring generally the first three weeks of employment for all consultants, can be designed to supplement/complete each consultant's competency in candidate management. The second phase of training for Career Coaches who provide services to candidates, can be targeted to enable them to achieve certification in the 12 Step Process of the present invention, by the end of their second month of employment. Respectively, for Contract Recruiters who provide recruiting services for clients, the second phase of training can be centered on achievement of certification on the 9 Step Talent Acquisition Process of the present inventions, by the end of month two. All consultants can be given classroom instruction, e.g., for 25% of their workweek, during, e.g., the first three weeks, supplemented by live observation of a certified consultant for the balance. In an exemplary embodiment, starting in week four, consultants can perform consulting services and be observed by a certified consultant and/or manager. Then the consultant can also be eligible to achieve certification on the end-to-end process. Once a Consultant becomes certified, he/she can be eligible to train and observe new associates.

Two days in each month can be set aside for co-education. One half of consultants can attend one session and the other half can attend the second. Managers can conduct an open forum to share new knowledge and to surface common issues. On an ongoing basis, Consultants can be expected to allocate a minimum of three paid hours per week for research and personal development. During this time, a consultant can be aided by managers, e.g., in how to study the consultant's specific clients, the industries that the consultant supports, and the human resources field, in general.

Consulting Processes

The operations of the career services provider can be built around the inventive processes delivered to candidates and clients including, e.g., the 9-step talent acquisition process, the 12-step job acquisition process and an outplacement process.

1. Talent Acquisition Process

Clients have the flexibility to outsource any step of the process to the career services provider. Some large employers have internal recruiting departments that handle the process flow and can simply use career services provider to source qualified candidates. However, many large companies are downsizing and outsourcing HR functions. Most smaller and newer companies have not yet developed HR capabilities leaving individual hiring managers to do their own recruiting. A career services provider can augment clients'capabilities in any mix to help them make successful placements. From client to client, what services are performed can vary greatly.

A exemplary embodiment of an end-to-end workflow for filling an open job using the present invention can include, e.g., any of the following:

| | | CE | CE |
|---|---|---|---|
| Steps in filling a job | Client | Content | Consultants |
| complete job requisition | ? | √ | √ |
| complete job description | ? | √ | √ |
| define the ideal candidate | ? | √ | √ |
| post the job internally | √ | na | na |
| post the job on CareerElite | ? | √ | √ |
| perform candidate search on CareerElite | ? | √ | √ |
| screen/narrow resumes from search for | ? | na | √ |
| relevance | | | |
| pre-screen candidates for interest and | ? | na | √ |
| availability | | | |
| direct candidates to an online | ? | √ | √ |
| assessment (optional) | | | |
| schedule phone interviews | ? | na | √ |
| conduct phone interviews (targeted | ? | na | √ |
| selection-based) | | | |
| narrow/rank the candidate pool | ? | √ | √ |
| present qualified pool to hiring | ? | na | √ |
| manager(s) | | | |
| schedule phone screens for hiring | ? | na | √ |
| managers (optional) | | | |
| select final candidate(s) for onsite | ? | na | √ |
| interviews | | | |
| obtain candidate compensation data | ? | √ | √ |
| perform reference checks | ? | √ | √ |
| schedule onsite interviews | ? | na | √ |
| make travel arrangements for | ? | na | √ |
| candidates/interviewers | | | |
| distribute selected company literature | ? | na | √ |
| (optional) | | | |
| arrange for welcome gift for candidates | ? | na | √ |
| (optional) | | | |
| create & distribute itineraries for | ? | na | √ |
| candidates/interviewers | | | |
| create & distribute interview guides to | ? | na | √ |
| all interviewers | | | |
| perform onsite interviews | √ | na | na |
| debrief with interviewer(s) for final | √ | na | √ |
| decision(s) | | | |
| arrange for second interviews, if | ? | na | √ |
| necessary (optional) | | | |
| create & distribute itineraries for | ? | na | √ |
| candidate/interviewers | | | |
| create & distribute interview guides to | ? | na | √ |
| all interviewers | | | |
| perform onsite interviews | √ | na | na |
| debrief with interviewer(s) for final | √ | na | √ |
| decision(s) | | | |
| decide offer amount and final package | √ | na | na |
| make verbal offer to finalist(s) | ? | na | √ |
| deliver formal offer letter to finalist(s) | √ | na | na |
| deliver turndown letters | √ | √ | na |
| initiate pre-employment drug testing | ? | √ | na |
| plan for on-boarding the new hire(s) | √ | √ | na |

? company decision to do internally or outsource to CareerElite
√ CareerElite content addresses the step and/or CareerElite consultants are available to do the work

A client engagement

Prospective clients can be targeted by our business development team that can be completely trained on the career services provider's operating capabilities. Once a sale (client engagement) occurs, the new client can be guided to determine which steps in the process they can perform internally and which ones they elect to outsource to career services provider consultants. The terms of engagement contract can be executed where both parties clearly understand “who” executes “which” specific step in the process flow. In an exemplary embodiment, the Talent Acquisition Process (above) can be completed in a collaborative manner with the client and attached as an Exhibit within the contract. A column called “Agreements” can be added to the far right of the document to allow for general agreements regarding time, process, contacts, mode of contact, etc. This Exhibit to the career services provider's contract can be used not only to initiate the career services provider's working relationship, but it can serve as a guide for both parties throughout the process.

Depending on the volume of work given to Career services provider, the career services provider can assimilate a client team to deliver the work. After closing but prior to beginning the engagement, Career services provider's business development team, led by the relationship manager who closed the sale, can engage in initial, detailed due diligence so that the career services provider can be properly prepared to represent them in the recruiting process. The due diligence can result in a Fact Report on the client covering the following parameters:

Business history, structure and location(s)

Leadership

Products and services

Industry Analysis

Financial performance

Customers, partners, alliances

Employment information (i.e., benefits, retirement, 401 k, etc.)

Open position(s) analysis

Culture

From an operations/execution standpoint, the career services provider's consultants possessing a clear understanding of the Fact Report is imperative. Further, it provides the career services provider's most powerful competitive advantage when coupled with the career services provider's personnel being highly qualified in delivering general recruiting and career coaching service. The career services provider's competence (as if the career services provider were part of the company) in articulating/selling the virtues of the client company and the specific job opportunity provide the value-add proposition for each client.

For each client engagement, depending on size and scope, the career services provider can recommend a regularly scheduled (weekly, bimonthly, etc.) meeting the career services provider call a pipeline review. In these meetings the career services provider can review progress to date, measure and manage expectations, solve problems, celebrate successes, and make work adjustments where needed.

2. Job Acquisition Process

Via the career services provider's web site, candidates have access to the career services provider's comprehensive 12 Step Process which guides them through their career planning with content and tools. Some candidates have changed jobs several times and can be able to independently achieve results without the assistance of a live Career Coach. However, many candidates desire to activate some live professional counseling to affirm and/or guide their actions. The career services provider's goal is to coach them successfully through the process while they perform and manage their own search. This is differentiated from the outsourcing process (3. below) where Career Coaches co-manage their job search. From candidate to candidate, specifically what the career services provider can do to help them can be very different—one step to multiple steps. Below is a typical, end-to-end workflow for finding a job:

| | CE | CE |
|---|---|---|
| Steps in finding a job | Content | Consultants |
| perform a self assessment | √ | √ |
| create/refine the resume | √ | √ |
| create cover letters | √ | √ |
| research industries, companies, cities | √ | √ |
| networking | √ | √ |
| job search | √ | na |
| manage multiple job searches | √ | na |
| prepare for interviews | √ | √ |
| create effective thank you letters | √ | √ |
| evaluate and negotiate an offer | √ | √ |
| resigning from current job | √ | √ |
| on-boarding into a new job | √ | √ |

A candidate engagement

As a candidate navigates the career services provider's web site, they are offered the opportunity to access a Career Coach. The Career Coach option is strategically positioned in numerous locations with easy access via a click-email option or a toll free phone number. These calls and emails can be instantly received by the career services provider's HelpDesk (see above) who can serve to clarify the specific need(s) of the individual. They can then determine if a session with a Career Consultant is desired, explain the pre-payment procedures, and proceed to schedule the chat within a guaranteed, 24 hour period. Access to all consultants calendars can be integrated into the career services provider's master scheduler. Sessions can be staged by the HelpDesk and driven by the candidate's requested time. The consultancy management can assign the session to individual consultants.

3. Outplacement Process

The career services provider's clients may, from time to time, need to incur incremental outplacement of personnel. Through the core 12 Step Process and the active support of a Career Coach, the career services provider can offer outplacement services billable on an hourly or retainer basis. The career services provider's outplacement process is similar to the job find process: however, the consulting time commitment and depth of mutual actions is significantly higher. Below is a typical, end-to-end workflow for outplacement services:

| Steps in finding a job | | CE | CE |
|---|---|---|---|
| while in outplacement | Candidate | Content | Consultants |
| review the employer's outplacement | na | na | √ |
| commitment | | | |
| develop a timeline, agree on role sort | √ | na | √ |
| review the 12 step process and draft | √ | na | √ |
| custom job find plan | | | |
| perform a self assessment | √ | √ | √ |
| create/refine the resume | √ | √ | √ |
| obtain letters of recommendation | na | na | √ |
| from employer (optional) | | | |
| create cover letters | √ | √ | √ |
| research industries, companies, cities | √ | √ | √ |
| co-networking (both candidate and | √ | √ | √ |
| CE consultant) | | | |
| co-job search (both candidate and CE | √ | √ | √ |
| consultant) | | | |
| co-manage multiple job searches | √ | √ | √ |
| prepare for interviews | √ | √ | √ |
| create effective thank you letters | √ | √ | √ |
| evaluate and negotiate an offer | √ | √ | √ |
| on-boarding into a new job | √ | √ | √ |

An outplacement engagement

Outplacement can differ from the job acquisition process in that the career services provider are engaged via a contract with the employer versus the candidate initiating the process. The terms of engagement contract can be executed where the paying company clearly understand what services can be extended to their outplaced associates. The chart above can be completed in a collaborative manner with the client and attached as an Exhibit within the contract. A column called “Agreements” can be added to the far right of the document to allow for general agreements regarding time, process, contacts, mode of contact, etc. This Exhibit to the career services provider's contract can be used not only to initiate the career services provider's working relationship, but it can serve as a guide for both parties throughout the process.

Depending on the volume of work given to Career services provider, the career services provider can assimilate a client team to deliver the work. After closing but prior to beginning the engagement, Career services provider's business development team, led by the relationship manager who closed the sale, can engage in initial, detailed due diligence so that the career services provider can be properly prepared to represent them in the outplacement process.

An Exemplary Embodiment of a Technology Implementation

Website Plan

The career services provider of the present invention builds a professional career management destination site rather than a convention job posting bulletin board. In an exemplary embodiment, features of the present invention encourage clients and candidates to be engaged and enable, beneficial use of the career services provider website end-to-end, through out the entire recruitment process. In an exemplary embodiment, the present invention can provide an easy-to-use, browser-based, graphical user interface (GUI), valuable tools and rich content.

Back End

In an exemplary embodiment, the career services provider web site can be built on a three-tier server structure. In an exemplary embodiment, a database management system 128 application server 114a such as, e.g., SQL Server available from Microsoft Corporation from Redmond, Wash., USA, a Web server 108a, 108b, such as, e.g., Internet Information Server (IIS) also available from Microsoft Corporation, running on an operating system platform such as, e.g., a Windows NT also from Microsoft Corporation, can be used. The web site, in an exemplary embodiment, can be developed preferably in ColdFusion, available from Allaire Corporation of Newton, Mass., U.S.A., for its ease of use and rapid application development time.

The career services provider, in an exemplary embodiment, is currently in the process of converting the ColdFusion code to Microsoft Active Server Pages (ASP) and Server-side Visual Basic Script. This can allow Career services provider more flexibility and power as the site moves forward. It can allow for greater scalability and faster page serving.

In an exemplary embodiment, an SQL server database, available from Microsoft Corporation of Redmond, Wash., U.S.A., can be used as database management system (DBMS)128. In an exemplary embodiment, the SQL database can run on an operating system platform including Windows NT available also from Microsoft Corporation. The DBMS and operating system platform support scalability and optimal power for the application server 114a, 114b of the present invention.

The career service provider can, in an exemplary embodiment, include active server pages. In an exemplary embodiment, web site code development and maintenance can be handled inhouse at the career service provider to provide security assurances to client and candidate data. Inhouse control can ease provision of applications to clients including use as client proprietary recruitment systems. In house applications support can allow for, in an exemplary embodiment, immediate response to client and candidate end user support issues, as well as quick turn-around for providing proprietary solutions to clients. In another exemplary embodiment, code development and maintenance can be handled externally via outsourcing agreements, including, e.g., service level agreements.

In an exemplary embodiment, the present invention can include use of a secure sockets layers (SSL) technology, an industry standard, to maintain the highest level of available Internet data transmission security. It will be apparent to those skilled in the art that other security technologies can be used, within the scope of the present invention.

In an exemplary embodiment, the web site can be hosted by a third-party on web servers 108a and 108b, and application servers 114a and 114b. In an exemplary embodiment the servers 108a, 108b, 114a and 114b can be provided by the career services provider. While the career services provider can retain administrator access to these servers 108a, 108b, 114a and 114b, in an exemplary embodiment, the third-party can provide wide area network (WAN) and/or Internet high bandwidth access, a high availability 24hours/7day per week network uptime, web server application support, proxy serving, network access serving, and operating system support to the computers. Third party hosting, in the exemplary embodiment, can ensure that any non-website specific problems with, e.g., the computing and network devices can be taken care of promptly by dedicated personnel, ensuring high availability. In an example embodiment, redundancy can be used throughout the site to ensure high availability. In another exemplary embodiment, hot and cold backup sites can be provided to provide for disaster recovery and increased uptime.

In an exemplary embodiment, standards-based state-of-the-art technologies can be deployed and supported as they emerge, by use of standards-compliant application, computer software, operating system, hardware and networking interfaces. The present invention supports such advanced technologies as, e.g., wireless web connectivity and alerts, electronic mail and message boards, database management systems, clustered multi-processor processing, advanced load balancing, firewalls, internet security and storage area networks and disk arrays. The present invention is not limited to these technologies but instead supports other emerging technologies.

Web Front End

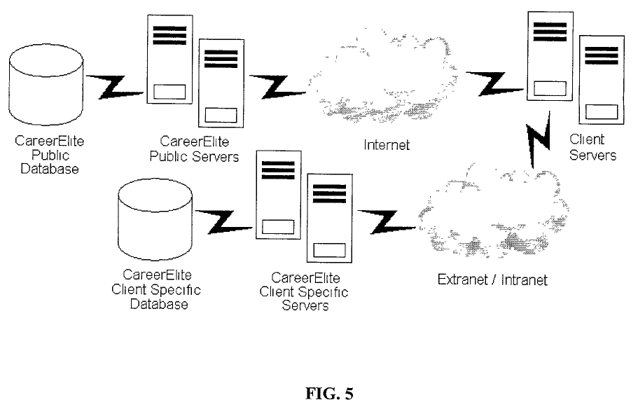

Web Servers 108a, 108b, in an exemplary embodiment, can provide public access to some resources. The public access web site, in an exemplary embodiment, can be divided into two distinct sections, a client (i.e., employer) side, and a candidate (i.e., job seeker, potential employee) side. The public access web site in an exemplary embodiment, as illustratively depicted in FIG. 5, can include provision of the following features:

| Client Side | Candidate Side |
|---|---|
| Job Requisition Builder | Job Search Engine |
| Job Postings Manager | Resume Builder |
| Candidate Manager | Auto Job Finder |
| Job Description Wizard | Job Search Scorecard |
| Intuitive Interview Guide | Self-Assessment Guide |
| Candidate Profile Builder | Cover Letter Builder |
| Candidate Compensation Summary | Compensation Consideration Tool |
| Auto Recruiter | Interview Preparation Guide |
| | Database Search Technology |
| | Thank You Letter Builder |
| | Prioritization Tool |
| | Offer Evaluation Guide & |
| | Assessment Tool |
| | Resignation Letter Builder |

Career Services Provider Application Service Provider (ASP)

FIG. 5 depicts an exemplary embodiment of a technology implementation of a career services provider, such as, e.g., Career services provider.com. FIG. 5 as illustratively depicted can include, in an exemplary embodiment, provision of application services in an application service provider (ASP) to clients. In an exemplary embodiment, the application can provide the career services provider web site functionality, but can have the have the application run on ASP technology resources as a stand-alone application for the client's proprietary use. In another exemplary embodiment, the application can be productized and run on client technology resources. This can allow the client to use the technologies and tools developed by the career services provider to run the career services provider on an in-house job recruitment site.

In an exemplary embodiment, the ASP can run the career services application on career services provider- (e.g., CareerElite.com) hosted client-dedicated servers that can be linked, in an exemplary embodiment, through, e.g., an extranet, a VPN, or an intranet to the client computers 118a, 118b. This can provide a separate secure server and database for the ASP 114a, 114b of the client 116a, 116b.

Career Services Provider Consultants

Career services provider consultants and coaches can manually record their billable calls in the career services provider billing system. As well, these people can have their phone time (the amount of time used to bill clients/candidates) logged by our internal phone system. Reports from this phone system can be uploaded to our billing server for auditing of the amount of time reported and billed for by the consultants and coaches.

Career Services Provider HelpDesk

The career services provider general helpdesk can be outsourced to a third-party. This helpdesk can aid users in utilizing the web site (i.e. navigation, using the tools) and basic questions regarding the site. If the questions are those that need consultation from career services provider coaches or consultants, the helpdesk personnel can aid the user in scheduling a callback.

In an exemplary embodiment, technical questions or billing questions that are not answerable by the helpdesk personnel can be forwarded to career services provider personnel either for immediate handling or on a callback basis.

As will be apparent to those skilled in the relevant art, network 106 can include a plurality of networks interconnected via, e.g., an internet and/or the global Internet. An internet (with a lower case “i”) is a network that connects multiple networks. The Internet (with a capitalized “I”) is an internet which connects computer workstation hosts in many networks which communicate using the Internet protocol (IP). Each host of the Internet has its own IP address, which can be used as a source or destination address in routing packets of information through the Internet. It will be apparent to those skilled in the art that network 106 can include various hardware and software elements such as, e.g., cabling, gateways, bridges, servers, network communication servers, proxy servers, switches, media gateways and routers.

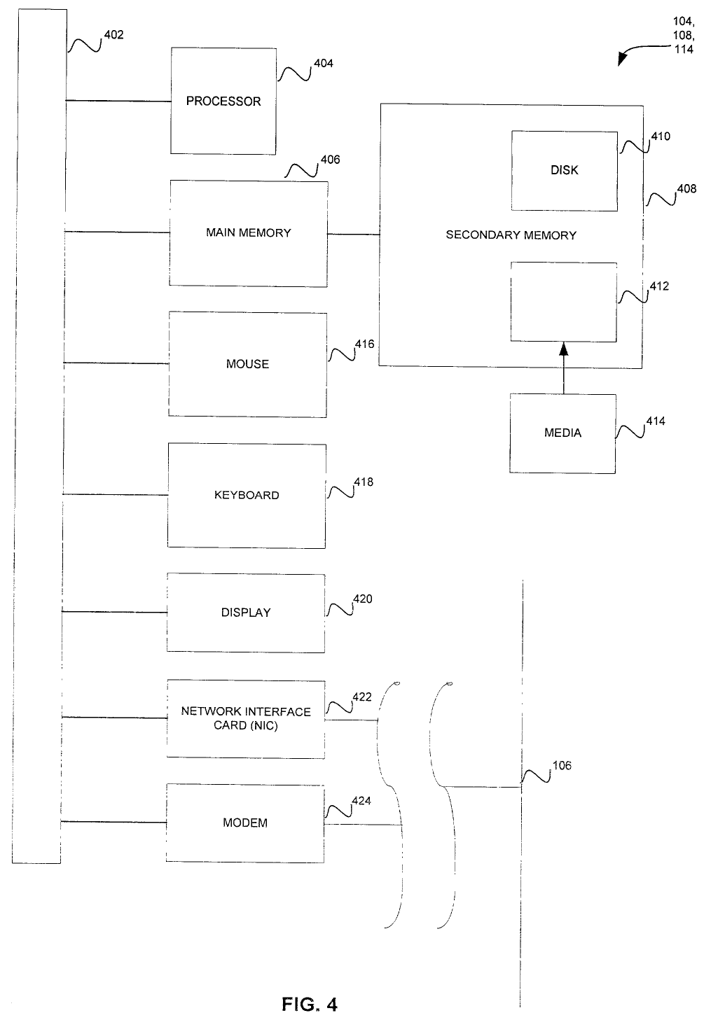

FIG. 4 depicts an exemplary embodiment of a computer system that could be used in the present invention. Specifically, FIG. 4 illustrates an exemplary embodiment of a computer 104, 108, 114 in a preferred embodiment is a client or server computer that can include, e.g., a personal computer (PC) system running an operating system such as, e.g., Windows NT/98/2000, LINUX, OS/2, Mac/OS, or other variant of the UNIX operating system. However, the invention is not limited to these platforms. Instead, the invention can be implemented on any appropriate computer system running any appropriate operating system, such as Solaris, Irix, Linux, HPUX, OSF, Windows 98, Windows NT, OS/2, Mac/OS, and any others that can support Internet access. In one embodiment, the present invention is implemented on a computer system operating as discussed herein. An exemplary computer system, computer 104, 108, 114 is illustrated in FIG. 4. Other components of the invention, such as client workstations, proxy servers, network communication servers, remote access devices, client computers, server computers, routers, web servers, data, media, audio, video, telephony or streaming technology servers could also be implemented using a computer such as that shown in FIG. 4.

The computer system 104, 108, 114 includes one or more processors, such as processor 402. The processor 402 is connected to a communication bus 404.

The computer system 104, 108, 114 also include a main memory 406, preferably random access memory (RAM), and a secondary memory 408. The secondary memory 408 can include, e.g., a hard disk drive 410, or storage area network (SAN) and/or a removable storage drive 412, representing a floppy diskette drive, a magnetic tape drive, a compact disk drive, etc. The removable storage drive 412 reads from and/or writes to a removable storage unit 414 in a well known manner.

Removable storage unit 414, also called a program storage device or a computer program product, represents a floppy disk, magnetic tape, compact disk, etc. The removable storage unit 414 includes a computer usable storage medium having stored therein computer software and/or data, such as an object's methods and data.

Computer 104, 108, 114 also includes an input device such as (but not limited to) a mouse 416 or other pointing device such as a digitizer, and a keyboard 418 or other data entry device.

Computer 104, 108, 114 can also include output devices, such as, e.g., display 420. Computer 104, 108, 114 can include input/output (I/O) devices such as, e.g., network interface cards 422 and modems 150 and 152.

Computer programs (also called computer control logic), including object oriented computer programs, are stored in main memory 406 and/or the secondary memory 408 and/or removable storage units 414, also called computer program products. Such computer programs, when executed, enable the computer system 104, 108, 114 to perform the features of the present invention as discussed herein. In particular, the computer programs, when executed, enable the processor 402 to perform the features of the present invention. Accordingly, such computer programs represent controllers of the computer system 104, 108, 114.

In another embodiment, the invention is directed to a computer program product comprising a computer readable medium having control logic (computer software) stored therein. The control logic, when executed by the processor 402, causes the processor 402 to perform the functions of the invention as described herein.

In yet another embodiment, the invention is implemented primarily in hardware using, e.g., one or more state machines. Implementation of these state machines so as to perform the functions described herein will be apparent to persons skilled in the relevant arts.

The present invention is directed to an employment candidate database that supports searching of candidates to yield cross industry comparable function candidates. A candidate is a user (e.g., an employee) that uses the career management system according to the present invention, in order to search for job openings available from clients. A client is a user (e.g., an employer) that uses the career management system according to the present invention, in order to post job openings searching for candidates that fill the job openings. According to an exemplary embodiment of the present invention, each record of the employment candidate database can be entered by a candidate performing a selection process of selection from a predefined list of industry selections, selection of a job function from a list of predefined job functions associated with the industry selected, selection of a job title from a list of predefined job titles, where comparable level job titles of different industries are related and comparable level job functions of different industries are related to achieve cross-level relationships. According to an exemplary embodiment of the present invention, a query tool can be provided that can allow a client to search cross-industry from the list of candidates in the employment candidate database whose work experience and/or current level correspond to a desired level. According to an exemplary embodiment of the present invention, a candidate job search process is managed according to a 12 step process. According to another exemplary embodiment of the present invention, a client talent acquisition process is managed according to a 9 step process. According to another exemplary embodiment, a human resource application service provider service can be provided to provide for the end-to end automation and management of the entire hiring process as an outsourcing service for businesses.

Search for Candidates by Cross-Industry Level

When a candidate registers as a new user of the career management system according to the present invention, the candidate selects a job title which is advantageously associated with other comparable cross-industry job titles including, e.g., the candidate choosing an industry selection from a predefined list of industries, selecting a job function from a predefined list of job functions within the previously selected industry that most closely matches the candidate's job function, selecting a job title from a predefined list of job titles associated with the previously selected job title.

For example, the industry, job function, and job title, can include, in an exemplary embodiment, descriptors detailing generally the industry, job function, and job title respectively. For example, the descriptors can detail, e.g., in the case of a job function or job title, responsibilities to assist the candidate in choosing the correct job function or job title. Transparent to users of the system, a candidate database automatically assigns a “cross-industry level” with the job function, or job title, for example, such as, e.g., a numeric, alphanumeric, grade level (e.g., A-F), or other identifier to rank a particular candidate's experience.

By pre-translating a job function or job title into the cross-industry “level” that the job function or job title is associated with, searches can later be performed against the candidate database for candidates with experience in a comparable position from another industry. In an exemplary embodiment, typically several jobs can be associated with a particular given same “level” assignment.

Benefit of including “Level” Search

Conventional on-line recruiting tools depend on “keyword” searches to deliver appropriate candidates. Unfortunately, if a specific candidate has not included the specific keyword typed by a client using a conventional career management system to search for candidates, then the search results provided to the client will not include the candidate's record even if otherwise qualified since the candidate did not use the same keyword to categorize the job experience. For example, if a company client was looking for a director of sales candidate, where the company client is seeking a candidate from a consumer products industry company, the company client would have to fill in all possible keywords associated with the titles, across industries, that are comparable to the director of sales of a consumer products manufacturer, to generate a candidate list of people who currently possess similar experiences and skills to the position to be filled.

A benefit of an exemplary embodiment of the career management system according to the present invention, is that by forcing candidates when registering to select a specific job title or job function from a predefined list, the search engine later, according to an exemplary embodiment of the present invention, can automatically generate a cross-industry list of all appropriate candidates, of all industries that have experience in a comparable “cross-industry” job function or job title. Likewise, the “cross-industry level” functionality, according to the present invention, allows a candidate to search for job openings across industries that are seeking candidates with comparable job functions or job titles. Thus, the search capability according to the exemplary embodiment of the present invention can be available for performing cross-industry searches by both candidates and clients.

According to an exemplary embodiment, to facilitate the cross industry “cross-leveling” jobs can be assigned relative weights. In another exemplary embodiment, each job function and job title can be translated into a generic numeric scale or ranking; the process of translating functions into scales or ranks is referred to as “cross-leveling.” Job functions and/or job titles that have the same scale or ranking associated with them are considered to be of “comparable cross-industry level.”

In creating a query, geographic preferences can be selected from a predefined regional category list and can be logically ORed together, whereas other criteria can be logically-ANDed in the query.

In another exemplary embodiment, a briefcase can be provided to the client to allow for reviewing multiple candidates at one time. In yet another exemplary embodiment, a briefcase of jobs can be provided yielding search results of a list of jobs meeting the criteria sought after in the query. According to an exemplary embodiment of the present invention, if a candidate finds a job that the candidate is interested in, using a single action such as, a mouse click on a button, the candidate's resume can be automatically provided to the client for review, and can be placed into the client's briefcase. Similarly, if a client finds a candidate via searching that the client is interested in, then the client with a similar single action can cause the client's job requisition form to be provided to the candidate. In another exemplary embodiment, any of the candidate, client, and/or a recruiter, can communicate with each other using, e.g., an 800 number, a point and talk voice over IP connection, hear me, email, video teleconferencing and CUCME.

Candidate Career Self Assessment and Job

The candidate career self assessment tool as depicted for example in FIG. 6, in an exemplary embodiment, is an on-line form that a candidate can fill out, e.g., at the beginning of the search process, clearly defining needs, such as, e.g., compensation requirements, and intangible desires, such as, e.g., quality of the management team, that can give the search focus. The assessment tool can be used to order various factors according to a relative prioritization. For example, the candidate can rank in numerical order from most important to least important, any of various factors such as, e.g., compensation factors, or subjective factors. Compensation factors can include, e.g., base salary, expected bonus/commission, company car/car allowance, stock options-estimated worth, retirement plan-yearly investment from the company, child care assistance, other compensation, gross signing bonus, and health insurance. Subjective factors can include, e.g., desired geographic location, job level, size of the company, career path potential, travel requirements, quality of direct manager, quality of management team, level of autonomy, whether the company is forward thinking, vacation time, relocation package, and quality and reputation of the company. Each factor can be assigned a numeric rank of importance, and then the system can automatically order the factors according to the ranked prioritization provided by the candidate's input.

Job Prioritization Tool

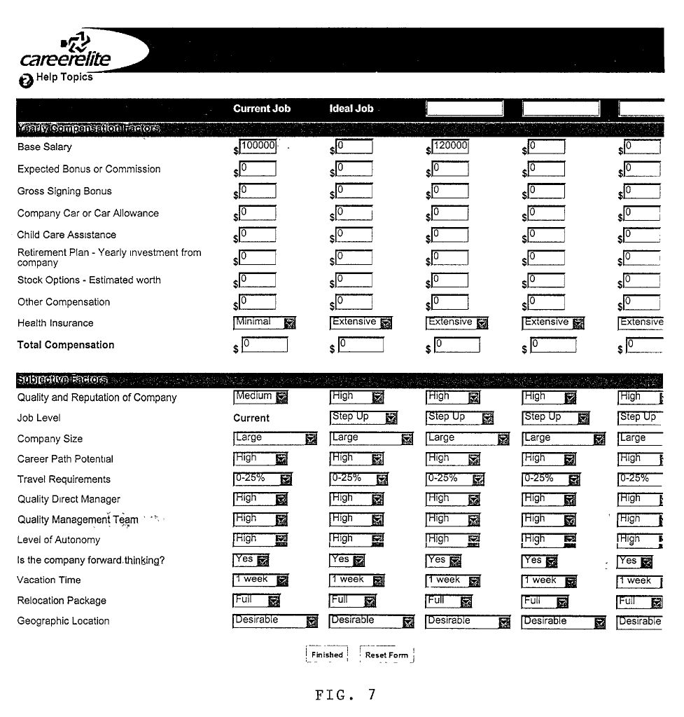

Another tool according to the present invention, somewhat similar to the candidate self assessment tool is a job prioritization assessment tool that can be used after one or more offers have been made to enable the candidate user to calculate, prioritize and compare the alternative offers side by side as depicted in FIG. 7, against the candidate's current position, and the items can be ordered according to the previously stated prioritizations, determined at the candidate's self assessment. Advantageously, the candidate user can review how an offer compares to the candidate's current position, and also in terms of the candidate's priorities. Likewise, alternative offers can be compared to determine which is the best offer based on both the quantitative compensation factors and qualitative subjective factors and can also be compared in order of priority to assist the user in making the best decision of alternative offers.

The assessment tools, in an exemplary embodiment, can serve two purposes: 1) the assessment tools can clearly capture the candidate's priorities and can help the candidate organize and think through all aspects of the candidate's job requirements, enabling the candidate to make data-based decisions and well thought-out decisions, and 2) the assessment tools can also serve as a driver of negotiation discussions to enable the candidate to identify clear negotiation points and to negotiate in a fact-based, non-emotional way with potential client employers.

Further, in one exemplary embodiment, if permitted by the candidate, a recruiter can review a candidate's priorities and can help to identify positions which are compatible with the candidate's compensation and subjective factors.

Blocking Individual Companies or Headhunters

It is very desirable to maintain the confidentiality of information about candidates who may be seeking a new position. Thus what is needed is a better way to allow the candidate to restrict access by a client to access to the candidate's resume, where the candidate may not want a specific client to be able to have access to the candidate's record and thus, may not want the candidate's record to appear in search results from the client's query. According to an exemplary embodiment of the present invention, a candidate can designate that, e.g., particular clients and/or recruiters, would not be provided access to the candidate's name, when searching for candidates that fit the candidate's criteria.

When a client registers with the career management system according to the present invention, the client must choose a company name from a predefined list of companies. Advantageously, in an exemplary embodiment, only one name can be permitted per company, or division of a company, to allow for selective access to search results. For example, a client company named “International Machines Company (IMC)” can be required during registration to use the name “International Machines Company” rather than the acronym “IMC” or some other name that the client could type in such as, e.g., “International Machines.” In one exemplary embodiment, only a company name can be permitted for all subsidiaries of the company, to allow for blocking access to search results including a candidate from the client company, where the candidate has selected to block its employer, i.e., the client company, from being able to see that the candidate has posted the candidate's resume. By requiring clients and candidates to log in using security features such as, e.g., a username and password, the career management system according to an exemplary embodiment of the present invention, can provide search results to the client employer that would not include, i.e., “block access” to the candidate's record where the candidate has requested blocking access to the candidate. Similarly, the candidate can block access to the client's record to a recruiter, if the system can identify a recruiter, using an identifier. In one exemplary embodiment, the company name of the client and any of various division names of the client can be forced to use the same company name to block access to a candidate's resume from the client.

To allow a candidate to seek an internal position in another division of the candidate's employer client company, in another exemplary embodiment, greater granularity of blocking can be provided by allowing the company to have separate divisions listed as clients, so that, e.g., a candidate could allow access to the candidate's resume by a client's pharmaceutical division, but not from the same client's retail division.

According to a candidate-specified candidate resume record blocking feature according to the present invention, in an exemplary embodiment, at the end of the registration process, candidates can choose to block specific client companies, all companies, and/or any, or all recruiters/headhunters from accessing the candidate's resume. The candidate-specified blocking feature can advantageously allow the candidate to maintain the candidate's job search in a selectable level of privacy.

The career management system according to the present invention, advantageously provides enhanced candidate identity privacy protection. In an exemplary embodiment, the candidate can select any of various levels of access that clients can obtain to the candidate's resume. For example, in an exemplary embodiment, the candidate can prevent the client from accessing certain information about the candidate, such as, e.g., access to grades, or other subsets of candidate information. In another exemplary embodiment, a recruiter might block access to contact information for a candidate, requiring the client to contact the recruiter first to be able to identify all the contact information for a candidate whose experience meets the client's search criteria.

Resume Builder Technology

The career management system according to an exemplary embodiment of the present invention can take information provided by a candidate entered during a registration process and can automatically download the information, e.g., onto both a formatted resume to print and use offline, as well as an ASCII or other standard format data file resume that can be used in on-line applications. The resume, in an exemplary embodiment can be formatted with all types of basic information, but can prompt the candidate to enter particular information such as, e.g., job description information and accomplishments, for each position. According to an exemplary embodiment, the resume builder can provide prompts or suggestions of phrasing, terms, descriptions, tasks, results, and other recommended data that the candidate can use to assist in describing each job position and accomplishment. In an exemplary embodiment, the job description can be printed in a paragraph format, and job accomplishments can be provided in bullet format. To assist candidates in producing an initial resume, in an exemplary embodiment, the resume builder of the present invention can include powerful examples of statements, and recommended ways to best phrase items such as describing accomplishments, for example. The resume generated by the resume builder can be printed, downloaded onto, e.g., a candidate's laptop or other computer, or could be provided to other job posting locations, and/or can be stored on the career management system according to an exemplary embodiment of the present invention.

The resume builder, in an exemplary embodiment of the present invention, can be an extremely user friendly process that can produce an effective resume in a very efficient manner. By providing predefined phrases, the candidate can be provided with a final resume that adheres to recommended, tested rules and/or formats. Examples of phrasing and of complete resumes and resume excerpts can be provided so as to help define what is important and to give examples on how to optimally describe and present a position for effective communication. In an exemplary embodiment of the present invention, a candidate can store the resume on the system, or can download the resume onto the user's computer for later access offline.

Job Scorecards and Candidate Scorecards

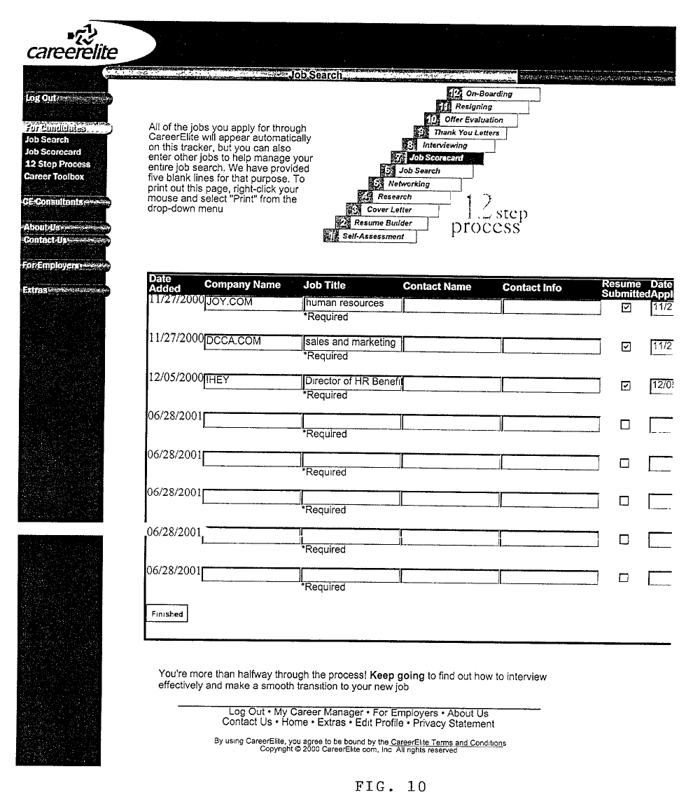

The career management system according to an exemplary embodiment of the present invention can provide a scorecard for candidates to use to manage all jobs and interviews in the search process such as, e.g., the candidate scorecard depicted in FIG. 10 from the beginning to end of the recruiting process, and a separate scorecard for clients to use to manage candidates (not shown) in an effective, organized manner.

The scorecard for the candidates as depicted in FIG. 10, in an exemplary embodiment, can identify jobs that the candidate has found by “searching” using, e.g., the cross-industry level search according to the present invention, and/or by using keyword or other criteria information such as, e.g., company name, job function, job title, title of position, contact info, etc. Once the candidate decides to apply, the job can be moved to a separate scorecard that can track information such as, e.g., the date a candidate submitted the resume of the candidate to the client and can provide a tracking tool for the candidate to use in managing follow up with the client. Table 1, below illustratively depicts an exemplary embodiment of column titles for a job scorecard such as, e.g., like that depicted in FIG. 10 that can be used by a candidate.

The scorecard for the clients, in an exemplary embodiment, can identify candidates, e.g., for a first cut by any information such as, e.g., total years of experience, geographic location preference, current cross-industry job level, industry, function, and job title. The client can then choose a relevant candidate list and can use the scorecard to narrow and prioritize the list without searching through all of what could be a long list of resumes. In another exemplary embodiment, the client can initially be provided a list of candidates which have accessed a job requisition, and can advantageously allow the client to focus efforts on reviewing the list of candidates which showed interest and can target the candidates whose queries resulted in accessing the client's job requisition.

Advantageously, the use of a scorecard, according to an exemplary embodiment of the present invention can streamline and standardize the process for both candidates and clients, saving additional effort and time.

Advantageously, the present invention provides a tool to manage the application process from beginning to end.

TABLE 1
Job Scorecard for Candidate

[chemical structure]

Define Candidate and Client Interview Guide Generator

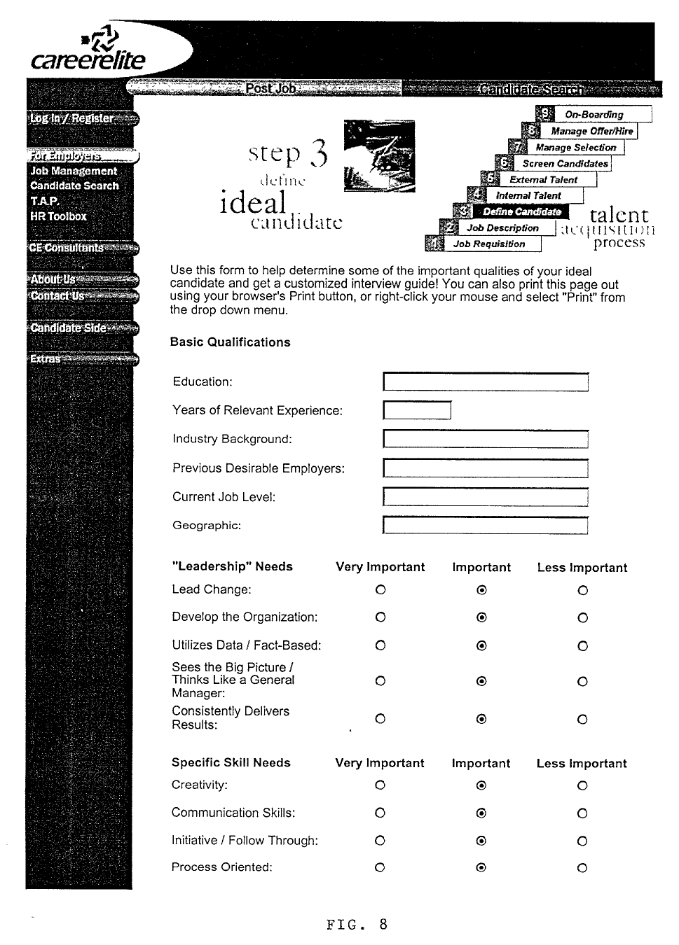

In an exemplary embodiment of the present invention, a client can provide a list of basic qualifications and can rank the relative importance of particular skill areas, motivation needs and desirable candidate leadership needs, as depicted in FIG. 8 . Basic qualifications can include, e.g., education, years of relevant experience, industry background, previous desirable employers, current job level, and geographic. Exemplary leadership needs include, e.g., leading change, develop the organization, utilizing data/fact-based, seeing the big picture/thinking like a general manager, and consistently delivering results. Specific skill needs include, e.g., creativity, communication skills, initiative/follow through, process oriented, people management/development, attention to detail, technical capacity, priority setting, and building value-centered relationships. Motivation needs can include, e.g., aggressive career plans, individual contributor, team contributor, risk tolerance, and outgoing.

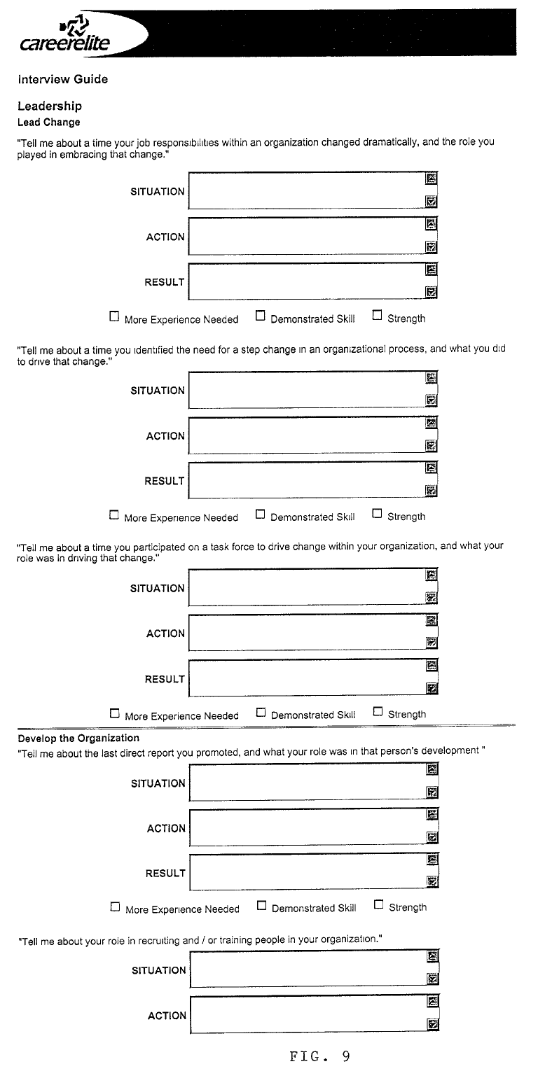

In an exemplary embodiment, clients can rank the importance of each particular skill in a list of skills as shown in FIG. 8, and then can activate a function that generates an interview guide as illustrated by FIG. 9, in an exemplary embodiment, with questions tailored to the skills ranked based on their importance.

In an exemplary embodiment, the interview guide of FIG. 9 can provide a list of questions to be asked in an interview and can enable all lines of contact to be on the same page at the outset of the interview process of the key profile of the individual needed to fill a particular job. This can also advantageously provide for a uniform evaluation of various alternative candidates by facilitating similar questioning of multiple candidates.

End to End Candidate Career Management Process

The career management process can include end-to-end managing of a candidate's career through an entire career transition process. According to an exemplary embodiment of the present invention, a candidate can be guided through all stages of the career management process, through the exemplary 12 steps depicted in FIGS. 6 and 10 from the beginning of a job search though the on-boarding process for a candidate.

The career management system according to an exemplary embodiment of the present invention can assist candidates through each step of the job search process to help the candidate identify and feel comfortable with each stage in the process. The twelve steps, in an exemplary embodiment include: 1) performing a self assessment, 2) developing a resume, 3) creating a cover letter, 4) researching jobs, companies, and industries, 5) networking, 6) searching for cross-industry level jobs, 7) applying for jobs and tracking application status with a job scorecard, 8) preparing for interviews and interviewing, 9) sending a thank you note, 10) considering and evaluating offers, 11) resigning, and 12)on-boarding from a candidate perspective.

The career management system according to the present invention offers tools and resources to make the job search process clear, simple, and unintimidating. The candidate is supported throughout the career management process with downloadable examples of letters to use and is guided through all the steps of a successful job search.

Conventional systems provide some automation of resumes and letters, but no conventional systems facilitate an end-to-end process of managing a job search.

End to End Talent Acquisition Management Process

According to an exemplary embodiment of the present invention, a nine step talent acquisition process (TAP) managing from end-to-end the entire hiring process. According to an exemplary embodiment of the present invention, an end-to-end process of automating the talent acquisition process is provided. In an exemplary embodiment, the TAP can include, as depicted in FIG. 8, e.g., 1) requisitioning a job, 2) describing a job, 3) defining a candidate that fills the need of the job, 4) reviewing internal talent, 5) reviewing external talent, 6) screening candidates, 7) managing selection of candidates, 8) managing offers and hiring a candidate, and 9) on boarding from a client perspective.

According to an exemplary embodiment of the talent acquisition process, a new job can be created by completion of a job requisition form, an example form can be provided with many helpful fields. The automated job requisition process is most helpful for small businesses like a startup which might provide little human resource guidance to a manager.

Job requisitions once completed can be available for search by candidates just as candidate resumes are available for search by a client trying to fill a job, alternatively, completed job requisitions could be forwarded to the human resource department. Creating a job requisition includes creating a job description. The job description wizard can take key words and can put the key words into a company form, with a company description, and responsibilities of the position. For functional groups, i.e., e.g., salespeople for a company without a large human resource department, they might skip the job description wizard.

In an exemplary embodiment a human resource application service provider (ASP) can include an human resource management solution workflow system which can manage the entire TAP process as an outsourced service for a business. Separately, in another exemplary embodiment, the TAP end-to-end client talent acquisition process automation system can be productized and sold to companies as a standalone recruiting management system.

In another exemplary embodiment, the end-to-end client talent acquisition process solution can include retention programs that can allow for seeking internal candidates that would meet the needs of the client.

Conventional solutions to management of the job search process unfortunately fall short in various ways. As will be apparent to the reader, conventional solutions touch on pieces of the career management process and talent acquisition process, however, unfortunately, conventional solutions do not provide a complete solution for facilitating the management of the candidate's job search, and similarly, conventional human resource management systems do not provide an end-to-end solution for managing the candidate search process. The reader is directed to the following documents which are relevant to career management, and exemplary of systems meeting a subset of the end-to-end cross-leveling functions, cross-industry searchable candidate and job database, according to the present invention: U.S. Pat. No. 5,978,768, “Computerized job search system and method for posting and searching job openings via a computer network,” to McGovern, et al., issued Nov. 2, 1999, U.S. Pat. No. 5,164,897, “Automated method for selecting personnel matched to job criteria,” to Clark et al., issued November 1992, U.S. Pat. No. 5,197,004, “Method and apparatus for automatic categorization of applicants from resumes,” to Sobotka et al., issued March 1993, and U.S. Pat. No. 5,416,694, “Computer-based data integration and management process for workforce planning and occupational readjustment,” to Parrish et al., issued May 1995, the contents of which are incorporated herein by reference in their entirety. While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method for providing an online end to end talent acquisition process for managing a client search for a candidate comprising:
(a) facilitating creation of a job requisition for a new job and storing said new job in a job database;
(b) receiving and storing in said job database a description of said new job of said job requisition including at least one of an industry, a job function and a job title;
(c) defining a desired candidate for said new job;
(d) receiving and executing a cross industry comparable level search query of a plurality of internal candidates for said desired candidate and returning internal candidates;
(e) receiving and executing a cross industry comparable level search query of a plurality of external candidates for said desired candidate and returning external candidates;
(f) facilitating screening said internal and external candidates;
(g) facilitating managing selection of at least one of said candidates;
(h) facilitating managing an offer and a hire of said at least one of said internal and external candidates; and
(i) facilitating managing an on-board process.

2. A method for providing an online end to end job search and career management process for managing a job search for a candidate comprising:
(a) facilitating performance of an receiving and storing results of a self assessment of a candidate, in a candidate database;
(b) facilitating building a resume for said candidate including receiving and storing a position job experience of said candidate n said candidate database including for said position at least one of: an industry of said position, a job function of said position, and a job title of said position;
(c) facilitating preparing a cover sheet for said resume;
(d) facilitating researching about clients and a desired job;
(e) facilitating networking for said candidate with said client for said desired job;
(f) facilitating receiving a cross industry comparable level search query and searching said candidate database for said desired job and presenting search results including resulting jobs;
(g) facilitating of and selection of at least one desirable job resulting scoring said job;
(h) facilitating interviewing for said at least one desirable job;
(i) facilitating preparing and sending a thank you letter after an interview for said desirable job;
(j) facilitating evaluating an offer for said desirable job;
(k) facilitating resigning from a prior position; and
(l) facilitating managing an on-boarding process.

3. A system for managing end-to-end an employment recruiting process comprising:
a network;
at least one web server coupled to said network;
a candidate database;
a client database; and
at least one application server coupled to said web server,
wherein said at least one application server comprises:
a database management system operative to manage said candidate and client databases, and
a career management application operative to manage at least one of a candidate job search and a client talent acquisition process from end-to-end.

4. The system according to claim 3, wherein said career management application comprises at least one of:
a revenue model including pay for performance;
live consultants accessible online to manage the career recruiting process;
an application service provider (ASP) offering operative to provide end to end human resource outsourcing application services to client human resources departments; and cross-industry comparable level search capabilities for candidates and clients.

5. A method for managing a candidate-selected candidate profile database comprising:
receiving candidate resumes having candidate selected job experience information including
selecting at least one of:
an industry from a plurality of a predefined industries,
a job function from a plurality of predefined job functions of said industry, and
a job position from a plurality of predefined job positions.

6. The method according to claim 5, further comprising receiving comparable cross-industry search queries for candidate resumes meeting comparable cross-industry criteria.

7. The method according to claim 6, wherein said comparable cross-industry search queries are by at least one of
said industry from a plurality of said predefined industries,
said job function from said plurality of predefined job functions of said industry, and
said job position from a plurality of said predefined job positions.

8. A computer program product embodied on a computer readable medium with computer program logic stored thereon, said computer program logic for managing a candidate-selected candidate profile database comprising:
means for enabling a computer to receive candidate resumes having candidate selected
job experience information including
means for enabling the computer to select at least one of:
an industry from a plurality of a predefined industries,
a job function from a plurality of predefined job functions of said industry, and
a job position from a plurality of predefined job positions.

9. The computer program product according to claim 8, further comprising:
means for enabling the computer to receive comparable cross-industry search queries for candidate resumes meeting comparable cross-industry criteria.

10. The computer program product according to claim 9, wherein said comparable cross-industry search queries are indexed by at least one of
said industry from a plurality of said predefined industries,
said job function from said plurality of predefined job functions of said industry, and
said job position from a plurality of said predefined job positions.
